(19) United States
(12) Patent Application Publication
(10) Pub. No.: US 2005/0140297 A1
(43) Pub. Date: Jun. 30, 2005

(54) Tubeless plasma display panel and manufacture of plasma display panel

(76) Inventor: Po-Cheng Chen, Yonghe City (TW)

Correspondence Address: BAKER & MCKENZIE;PATENT DEPARTMENT, 2001 ROSS AVENUE, SUITE 2300, DALLAS, TX, 75201, US

(21) Appl. No.: 10/749,840

(22) Filed: Dec. 29, 2003

(51) Int. Cl. H01J 9/00; H01J 9/26; H01J 17/49; H01J 9/46

(52) U.S. Cl. 313/582; 445/24; 445/25; 445/66

(57) ABSTRACT

The present application describes a system and method for manufacturing a plasma display panel. According to an embodiment, the plasma display panel includes display cells formed between a front substrate and a rear substrate. The display cells are filed with a gaseous mixture by placing the front and rear substrates inside an inner cavity of a processing chamber before the front and rear substrates are sealed together. The processing chamber is sealed after the front and rear substrates are placed inside the inner cavity of the processing chamber. The gaseous impurities are removed from the display cells and the inner cavity of the processing chamber is filled with a discharge gas. The discharge gas flows into the display cells through the lateral sides of the plasma display panel assembly. After the display cells are filed with the discharge gas, the front and rear substrates are sealed together inside the inner cavity of the processing chamber.

### FIELD OF THE INVENTION

The present invention generally relates to plasma display panels, and more particularly, to a system and method for manufacturing a plasma display panel.

### DESCRIPTION OF THE RELATED ART

Generally, plasma display panels are used as large screen displays. Typically, plasma display panels are flat and provide better image quality compared to cathode ray tube displays. Plasma display panels include display cells filled with a discharge gas. Each display cell is coated with a light-emitting layer typically made of a phosphorous-based material. To produce an image in the plasma display panel, an electric bias is applied to select one or more display cells. Upon receiving the electrical bias, the discharge gas in the selected display cell emits ultraviolet rays. When ultraviolet rays strike the light-emitting layer of the selected display cell, the light-emitting layer produces a visible color light. The color of the visible light depends upon the composition of the phosphorous-based material of the light-emitting layer.

FIGS. 1A-1E illustrate a known conventional process of manufacturing a plasma display panel 100. Referring to FIG. 1A, a plasma display panel 100 comprises two glass substrates, a front substrate 110 and a rear substrate 112 joined together to form a gap 120. A tube 134 is mounted on the rear substrate 112 using beads of a sealing material 144a. A vacuum nozzle 132 is coupled to the tube 134. The vacuum nozzle 132 is configured to pump impurities out of the gap 120 and fill a discharge gas into the gap 120. Referring to FIG. 1B, display cells 114 are formed within the gap 120. The display cells 114 are separated by partition walls 116. Each display cell 114 includes a light-emitting layer 118 made from a phosphorus-based material. The layer 118 corresponds to a specific color of light emission.

The rear substrate 112 includes an opening 115 under the tube 134. The front substrate 110 and the rear substrate 112 are joined together using a bead of sealing material 142a. Typically, the sealing materials 142a and 144a comprises a mixture of glass frit and organic resin. The sealing materials 142a and 144a are heated to melt the glass frit and bum-off the organic resin. After the heating, the beads of sealing materials 142a and 144a convert into impermeable seals 142b and 144b respectively as shown in FIG. 1C.

Referring to FIG. 1D, unwanted gaseous impurities are initially removed from the gap 120 via the tube 134 using a vacuum pump (not shown) because for an efficient emission of ultraviolet rays from the discharge gas, the discharge gas must be clear of all impurities. Referring to FIG. 1E, after removing gaseous impurities from the gap 120, the discharge gas is filled into the gap 120 via the tube 134. Referring to FIGURE IF, once the gap 120 is filled with a desired amount of discharge gas, the tube 134 is sealed to block discharge gas leakage. Typically, the tube 134 is cut using a melting process to sever the tube 134 from the vacuum nozzle 132 while sealing the tube 134. Therefore, the plasma display panel 100 typically includes a protruding tip 136 over the rear substrate 112. The protruding tip 136 is a remaining portion of the cut tube 134.

FIG. 1G is a temperature graph illustrating a change of temperature during the process of manufacturing the plasma display panel 100. Initially, the temperature of the plasma display panel 100 is raised to a temperature T1 during the time t₁ to form the impermeable sealing 144b between the front substrate 110 and the rear substrate 112. After the impermeable sealing 144b is formed, the temperature of the plasma display panel 100 is lowered to a temperature T2. The gas pumping is then performed to remove impurities from the gap 120 during the time t₂. The processing temperature is then reduced to fill the discharge gas in the gap 120.

The plasma display panel 100 includes protruding tube tip 136, which can be damaged during the transportation of the plasma display panel 100. Further, the time required for evacuating the gaseous impurities from the gap 120 is typically long and non-uniform because the gaseous impurities must exit from the opening 115. Therefore, there is a need for a system and method of manufacturing plasma display panels that can overcome the disadvantages of the conventional manufacturing process.

### SUMMARY OF THE INVENTION

The present application describes a system and method for manufacturing a plasma display panel with substantially flat surfaces without tubular protrusions. The plasma display panel includes display cells formed between a front substrate and a rear substrate. Each display cell includes a light-emitting layer. The display cells are filled with a discharge gas before the front and rear substrates are sealed together. According to an embodiment, the display cells are filed with the discharge gas by placing the plasma display panel assembly including the front and rear substrates in an inner cavity of a processing chamber. The processing chamber is sealed after the assembly is placed into the inner cavity. The inner cavity of the processing chamber is then filled with the discharge gas and the discharge gas flows into the display cells through the lateral sides of the plasma display panel assembly. After the display cells are filed with the discharge gas, the front and rear substrates are sealed inside the inner cavity of the processing chamber and then removed from the processing chamber.

According to one embodiment, the processing chamber includes a base plate and a gas distribution plate. The base plate and the gas distribution plate are coupled together to form the inner cavity. After the plasma display panel assembly is placed inside the inner cavity, the base and gas distribution plates are sealed together before the inner cavity is filled with the discharge gas. The gas distribution plate includes an inlet hole for dispensing the discharge gas inside the inner cavity of the processing chamber. According to one embodiment, the base and gas distribution plates are made of a glass material.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIGS. 1A-1F illustrate a conventional process of manufacturing a plasma display panel;

FIG. 1G is a temperature graph illustrating a change of temperature during the conventional process of manufacturing the plasma display panel;

FIG. 2A illustrates a processing chamber for manufacturing a plasma display panel;

FIG. 2B shows an impermeable sealing formed between two plates of the processing chamber for manufacturing the plasma display panel;

FIG. 2C illustrates a process of evacuating gaseous impurities from display cells formed between two substrates of the plasma display panel;

FIG. 2D illustrates a process of filling a discharge gas inside the display cells of the plasma display panel;

FIG. 2E illustrates a process of forming a sealing between two substrates of the plasma display panel;

FIG. 2F illustrates a plasma display panel manufactured without protruding tube tips;

FIG. 2G is a temperature graph illustrating the temperature of the processing chamber during the manufacturing of the plasma display panel;

FIG. 2H is a pressure graph illustrating the internal pressure of the processing chamber during manufacturing of a plasma display panel;

FIG. 3 illustrates a processing chamber for manufacturing a plasma display panel using alternate sealing means between two plates of the processing chamber; and

FIG. 4 is a flowchart illustrating an exemplary sequence of steps performed during a process of manufacturing a plasma display panel.

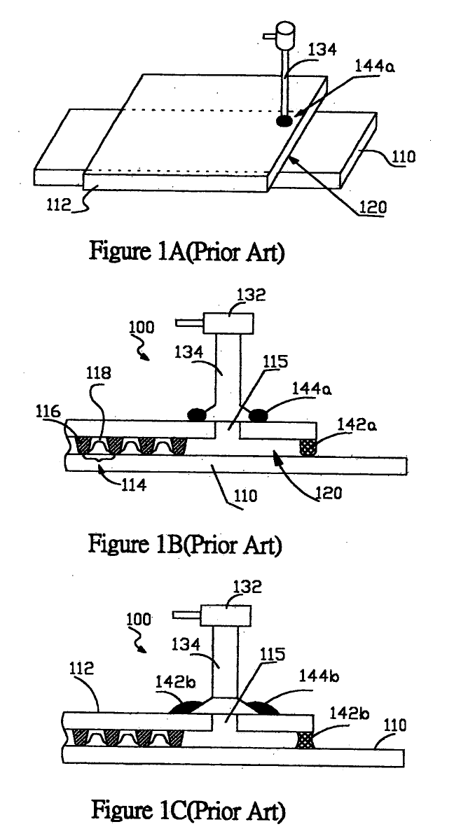

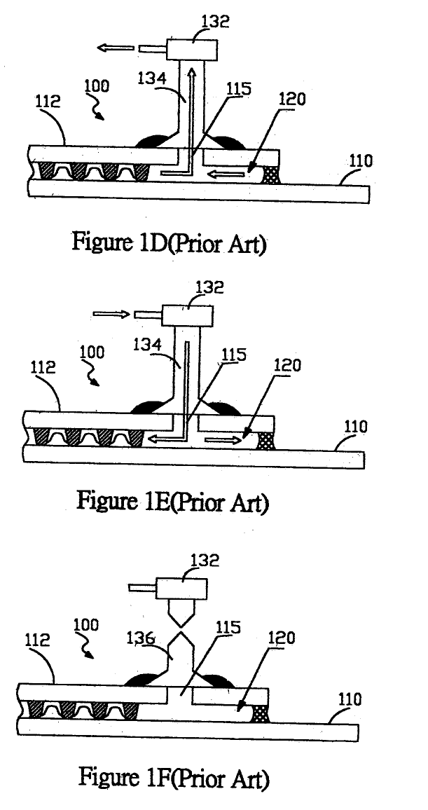

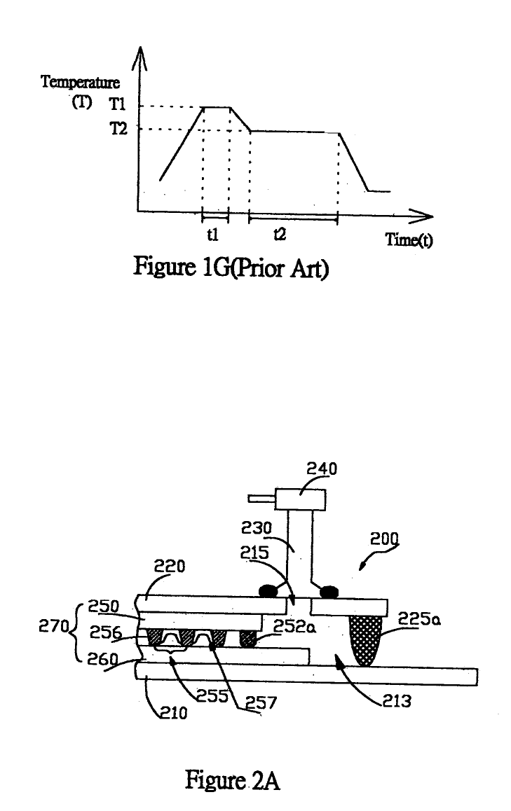

### DETAILED DESCRIPTION OF THE EMBODIMENT(S)

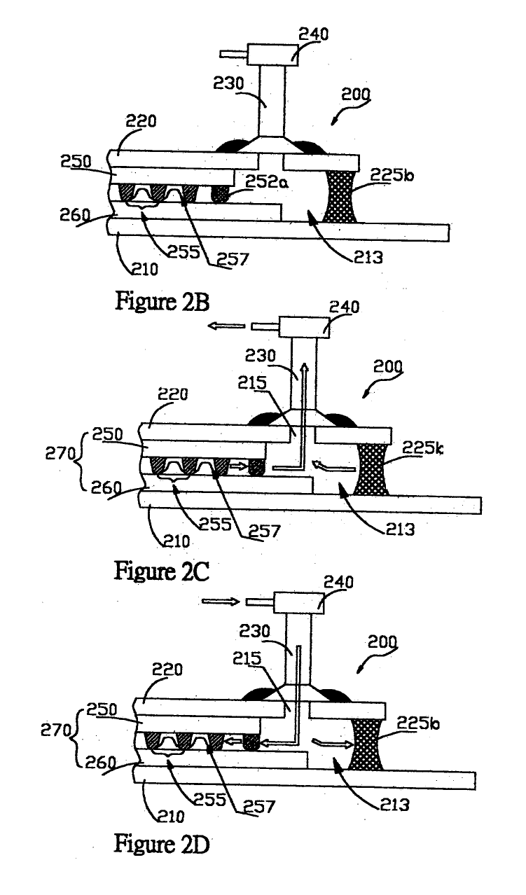

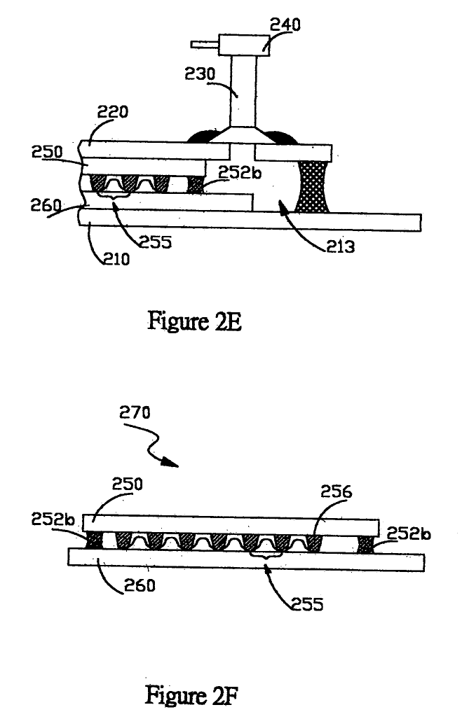

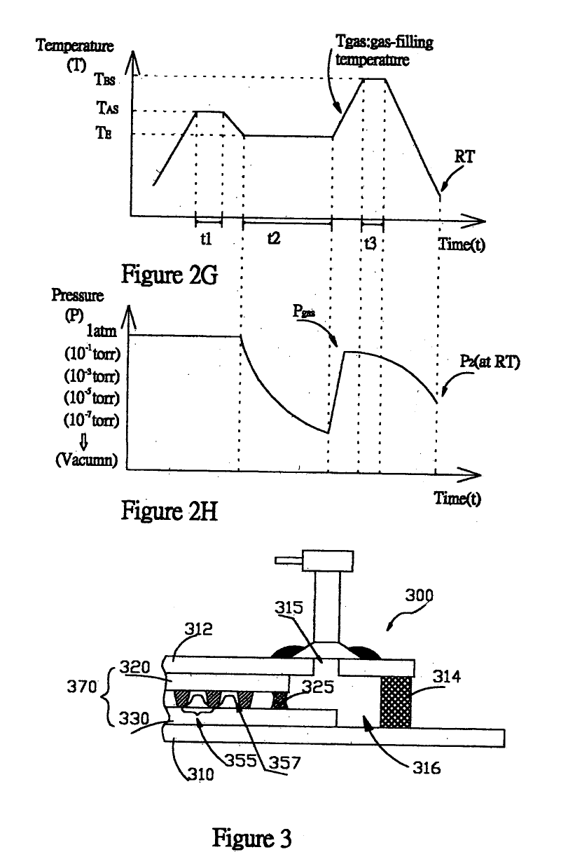

FIG. 2A illustrates a processing chamber 200 for manufacturing a plasma display panel 270. The processing chamber 200 includes a base plate 210 and a gas distribution plate 220. The base plate 210 and the gas distribution plate 220 can be made from glass. The gas distribution plate 220 includes an opening 215. The base plate 210 and the gas distribution plate 220 are coupled together via a sealing 225a to form a cavity 213. The sealing 225a is initially deposited as a bead of a sealing material. In the present example, the sealing 225a comprises a crystallizing sealing material, which is heated to a sealing temperature to make the sealing impermeable. A gas flow tube 230 is mounted on the opening 215 of the gas distribution plate 220. The gas flow tube 230 can be made from glass. A vacuum nozzle 240 is coupled to the gas flow tube 230. The vacuum nozzle 240 can be connected to a gas supply unit (not shown) to provide the discharge gas and a gas-pumping unit (not shown) for removing gaseous impurities from the processing chamber 200.

An assembly of a plasma display panel 270 is placed inside the cavity 213. The assembly of the plasma display unit 270 includes a rear substrate 250 and a front substrate 260. The rear substrate 250 and the front substrate 260 are coupled together with a sealing 252a. The sealing 252a is initially deposited as a bead of a sealing material. In the present example, the sealing 252a comprises a crystallizing sealing material, which is heated to a sealing temperature to make the sealing impermeable. The sealing temperature of the sealing material 252a is higher than the sealing temperature of the sealing material 225a. Display cells 255 are formed between the rear substrate 250 and the front substrate 260. The display cells 255 are separated by rib barriers 256. Each display cell 255 includes a light-emitting layer 257 made of a phosphorous-based material. The sealing material 252a is placed at the periphery of an area enclosing the display cells 255. The sealing material 252a is heated to a sealing temperature to make the sealing between the two plates impermeable.

FIG. 2B shows a sealing formed between two plates of the processing chamber 200. Initially, the bead of sealing material 225a joining the base plate 210 and the gas distribution plate 220 is heated to its sealing temperature to make an impermeable seal 225b. The impermeable seal 225b hermetically seals the cavity 213. Because the sealing temperature of the sealing material 252a is higher than the sealing temperature of the sealing material 225a, the sealing material 252a remains unchanged.

FIG. 2C illustrates a process of evacuating gaseous impurities from display cells formed between two substrates of the plasma display panel 270. A gas pump (not shown) removes gaseous impurities from the display cells 255 via the glass tube 230. Because the rear substrate 250 and the front substrate 260 of the plasma display panel 270 are not sealed together, more gaseous impurities can evacuate from the lateral sides of the plasma display panel 270, which results in an enhanced emission of light from the light-emitting layers 257. The evacuation of gaseous impurities is accomplished more efficiently and faster than the conventional manufacturing process.

FIG. 2D illustrates a process of filling discharge gas in display cells of the plasma display panel 270. The discharge gas can be a gaseous mixture of inert gases including Xenon (Xe), Neon (Ne), or Helium (He). After gaseous impurities have been removed from the display cells 255, the discharge gas is filled into the display cells 255 through the gas tube 230. Because the rear substrate 250 and the front substrate 260 of the plasma display panel 270 are not sealed together, the discharge gas flows into the display cells 255 from the lateral sides of the plasma display panel 270 within the processing chamber 200. The display cells 255 are filled with the discharge gas faster and more efficiently than the conventional plasma display manufacturing process.

FIG. 2E illustrates a process of forming a sealing between the rear substrate 250 and the front substrate 260 of the plasma display panel 270. After the display cells 255 are filed with the discharge gas, the processing chamber 200 is heated to a sealing temperature of the sealing material 252a to seal the substrates of the plasma display panel 270.

FIG. 2F illustrates the plasma display panel 270 manufactured without a protruding tube tip. When the temperature inside the processing chamber 200 reaches the sealing temperature of the sealing material 252a, the sealing material 252a is converted into an impermeable seal 252b, which hermetically confines the discharge gas within the display cells 255. After the front and rear substrates of the plasma display panel 270 are sealed together, the plasma display panel 270 can be removed from the processing chamber 200. The substrates 250 and 260 are free of tubes, tubular portions, gas channel, or equivalent structures. The plasma display panel 270 has a substantially flat rear surface, which is free of tubular protrusions.

FIG. 2G is a temperature graph illustrating the temperature of the processing chamber 200 during the manufacturing of the plasma display panel 270. Initially, the processing chamber is heated during the time t₁ to a temperature T_{AS}, which is the sealing temperature of the sealing material 225a of the processing chamber 200. The temperature T_{AS} can be determined by the manufacturer of the sealing material 225a based on the composition of the sealing material. After the sealing material 225a is converted into an impermeable seal 225b, the temperature of the processing chamber is reduced to a filling temperature T_{E} during the time t₂.

When the temperature of the processing chamber reaches the filling temperature T_{E}, gaseous impurities are removed from the processing chamber 200 and the discharge gas is filled into the display cells 255. The filling temperature T_{E} can be determined according to the properties of the discharge gas mixture used for the display cells. After the display cells are filled with the discharge gas, the processing chamber 200 is heated during the time t₃ to a temperature T_{BS}, which is the sealing temperature of the sealing material 252a. The sealing material 252a is used to seal the rear substrate 250 with the front substrate 260 of the plasma display panel 270. The sealing temperature T_{BS} can be determined by the manufacturer of the sealing material 252a based on the composition of the sealing material 252a. After the sealing material 252a is converted into an impermeable seal 252b, the temperature of the processing chamber is reduced to an ambient temperature RT and the plasma display panel 270 is removed from the processing chamber 200.

FIG. 2H is a pressure graph illustrating the internal pressure of the processing chamber 200 during the manufacturing of the plasma display panel 270. When the display cells 255 are substantially filled with the discharge gas, the internal pressure of the processing chamber 200 reaches a predetermined pressure P_{gas}. After the sealing material 252a is converted into an impermeable seal 252b and the temperature of the processing chamber 200 reaches the ambient temperature RT, the internal pressure of the processing chamber normalizes at pressure P₂. The pressure P_{gas} can be determined according to various factors such as, for example, a size of the plasma display panel 270, a number of display cells 255 within the plasma display panel 270, a type of gaseous mixture used for the discharge gas, and the like.

FIG. 3 illustrates a processing chamber for manufacturing a plasma display panel using alternate sealing means between two plates of a processing chamber 300. The processing chamber 300 includes a base plate 310 and a gas distribution plate 312. The base plate 310 and the gas distribution plate 312 can be made from glass. The gas distribution plate 312 includes an opening 315. The base plate 310 and the gas distribution plate 312 are coupled together via a sealing 314 to form a cavity 316. A plasma display panel 370 is placed inside the cavity 316. The plasma display panel 370 includes a front substrate 330 and a rear substrate 320 joined together with a sealing 325. The front substrate 330 and the rear substrate 320 form display cells 355. Each display cell includes a light-emitting layer 357.

In the present example, the sealing 314 is an O-ring type fastener that can be desirably fastened and detached from the base plate 310 and the gas discharge plate 312. The sealing 314 is reusable. The reusable sealing 314 results in a simple and economical manufacturing process because the deposition and heating of the sealing material 314 is not required during the gas-filling process for each plasma display panel.

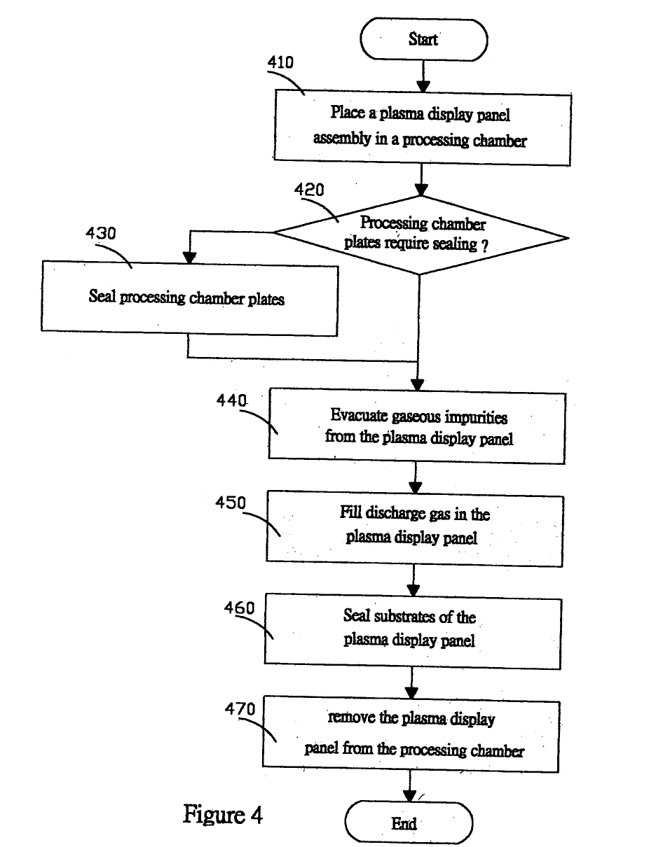

FIG. 4 is a flowchart illustrating an exemplary sequence of steps performed during a process of manufacturing a plasma display panel. For purposes of illustration, various steps are described in particular order, however, when supported by accompanying system elements, these steps can be performed in any order, serially or in parallel. Initially, a plasma display panel assembly is placed in a processing chamber (410). The processing chamber can include various types of sealing means for the base plate and the gas distribution plate as described previously herein. Next, it is determined whether the plates of the processing chamber require sealing (420). If plates of the processing chamber require sealing, then plates are sealed (430) for example, by increasing the internal temperature of the processing chamber to a sealing temperature of the sealing material used to join plates.

If plates of the processing chamber do not require sealing, then gaseous impurities from the plasma display panel are evacuated (440). A discharge gas is then filed into the plasma display panel (450). The plasma display panel is then sealed (460). The plasma display panel can be sealed, for example, by increasing the internal temperature of the processing chamber to a sealing temperature of the sealing material used to join the front substrate and the rear substrate of the plasma display panel. The plasma display panel is then removed from the processing chamber (470). The plasma display panels manufactured using the process described herein have a substantially flat rear surface, which is free of tubular protrusions.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

The section headings in this application are provided for consistency with the parts of an application suggested under 37 CFR 1.77 or otherwise to provide organizational cues. These headings shall not limit or characterize the invention(s) set out in any patent claims that may issue from this application. Specifically and by way of example, although the headings refer to a “Field of the Invention,” the claims should not be limited by the language chosen under this heading to describe the so-called field of the invention. Further, a description of a technology in the “Description of Related Art” is not be construed as an admission that technology is prior art to the present application. Neither is the “Summary of the Invention” to be considered as a characterization of the invention(s) set forth in the claims to this application. Further, the reference in these headings to “Invention” in the singular should not be used to argue that there is a single point of novelty claimed in this application. Multiple inventions may be set forth according to the limitations of the multiple claims associated with this patent specification, and the claims accordingly define the invention(s) that are protected thereby. In all instances, the scope of the claims shall be considered on their own merits in light of the specification but should not be constrained by the headings included in this application.

1. A processing chamber for manufacturing a plasma display panel comprising a plurality of display cells, the processing chamber comprising:
a base plate;
a gas distribution plate operable for coupling to the base plate via a first sealing element, wherein an inner cavity is formed between the base plate and the gas distribution plate; and
a gas flow tube mounted over an opening in the gas distribution plate and configured to fill the plurality of display cells of the plasma display panel assembly placed in the inner cavity with a gaseous mixture.

2. A processing chamber according to claim 1, wherein the gaseous mixture flows into the plurality of display cells via lateral sides of the plasma display panel assembly.

3. A processing chamber according to claim 1, wherein the gas flow tube comprises a glass material.

4. A processing chamber according to claim 1, wherein the first sealing element is configured to hermetically seal the inner cavity between the base and gas distribution plates upon heating of the processing chamber to a first sealing temperature.

5. A processing chamber according to claim 4, wherein the first sealing element comprises a crystallizing sealing material.

6. A processing chamber according to claim 1, wherein the first sealing element is an O-ring configured to hermetically seal the inner cavity between the base and gas distribution plates.

7. A processing chamber according to claim 1, wherein at least one of the base and gas distribution plates comprises a glass material.

8. A processing chamber according to claim 1, further comprising:
a vacuum unit coupled to the gas flow tube and configured to remove gaseous impurities from the plurality of display cells.

9. A processing chamber according to claim 1, wherein the plasma display panel assembly comprises:
a front substrate;
a rear substrate operable for coupling to the front substrate by a second sealing element; and
a plurality of display cells formed between the front substrate and the rear substrate, the display cells being delimited by partition walls, and the display cells including light-emitting layers configured to emit light of at least one color,
wherein the second sealing element is configured to hermetically seal the front and rear substrates upon heating of the processing chamber to a second sealing temperature.

10. A method of filling a plurality of display cells of a plasma display panel with a gaseous mixture, the method comprising:
placing a plasma display panel assembly in an inner cavity of a processing chamber;
filling the inner cavity of the processing chamber with the gaseous mixture;
sealing the plasma display panel assembly inside the inner cavity of the processing chamber; and
removing the plasma display panel assembly from the inner cavity of the processing chamber.

11. The process according to claim 10, wherein placing the plasma display panel in the inner cavity of the processing chamber further comprises:
placing the plasma display panel assembly between the base and distribution plates;
coupling a base plate and a gas distribution plate using a first sealing element to form the inner cavity of the processing chamber; and
sealing the inner cavity between the base and distribution plates.

12. A method according to claim 11, wherein the first sealing element is an O-ring.

13. A method according to claim 11, wherein the first sealing element comprises a crystallizing sealing material and the inner cavity is sealed by heating the processing chamber to a first sealing temperature.

14. A method according to claim 13, wherein
a front substrate and a rear substrate of the plasma display panel assembly are coupled together by a second sealing element;
the second sealing element is configured to hermetically seal the front and rear substrates upon heating of the processing chamber to a second sealing temperature; and
the second sealing temperature is greater than the first sealing temperature.

15. A method according to claim 13, wherein the gaseous mixture flows into a plurality of display cells formed between the front and rear substrates of the plasma display panel assembly via lateral sides of the plasma display panel assembly.

16. A method according to claim 10, further comprising:
substantially evacuating gaseous impurities from the plasma display panel assembly before filling the inner cavity of the processing chamber with the gaseous mixture.

17. A method according to claim 10, wherein the gaseous mixture comprises at least one inert gas selected from the group consisting of Xenon (Xe), Neon (Ne), and Helium (He).

18. A plasma display panel comprising:
a front substrate;
a rear substrate coupled to the front substrate; and
a plurality of display cells formed between the front substrate and the rear substrate, the display cells being delimited by partition walls, and the display cells including light-emitting layers configured to emit light of at least one color,
wherein the front and rear substrates are substantially flat and do not include a protrusion remaining from a tube that was operable to fill the plasma display panel with a gaseous mixture.

19. A plasma display panel including a plurality of display cells, the plasma display panel comprising a front substrate and a rear substrate, wherein the front and rear substrates do not include a protrusion, the plasma display panel made by a process comprising:
placing a plasma display panel assembly in an inner cavity of a processing chamber;
filling the inner cavity of the processing chamber with a gaseous mixture;
sealing the plasma display panel assembly inside the inner cavity of the processing chamber; and
removing the plasma display panel assembly from the inner cavity of the processing chamber.

20. The plasma display panel according to claim 19, wherein placing the plasma display panel in the inner cavity of the processing chamber further comprises:
placing the plasma display panel assembly between a base plate and a distribution plate;
coupling the base and distribution plates using a first sealing element to form the inner cavity of the processing chamber; and
sealing the inner cavity between the base and distribution plates.

21. A plasma display panel according to claim 19, wherein the first sealing element is an O-ring.

22. A plasma display panel according to claim 19, wherein the first sealing element comprises a crystallizing sealing material and the inner cavity is sealed by heating the processing chamber to a first sealing temperature.

23. A plasma display panel according to claim 22, wherein
a front substrate and a rear substrate of the plasma display panel assembly are coupled together by a second sealing element;
the second sealing element is configured to hermetically seal the front and rear substrates upon heating of the processing chamber to a second sealing temperature; and
the second sealing temperature is greater than the first sealing temperature.

24. A plasma display panel according to claim 22, wherein the gaseous mixture flows into a plurality of display cells formed between the front and rear substrates of the plasma display panel assembly via lateral sides of the plasma display panel assembly.

25. A plasma display panel according to claim 19, wherein the process further comprises:
substantially evacuating gaseous impurities from the plasma display panel assembly before filling the inner cavity of the processing chamber with the gaseous mixture.

26. A plasma display panel according to claim 19, wherein the gaseous mixture comprises at least one inert gas selected from the group consisting of Xenon (Xe), Neon (Ne), and Helium (He).
